(19) United States
(12) Patent Application Publication
(10) Pub. No.: US 2023/0205921 A1
(43) Pub. Date: Jun. 29, 2023

(54) DATA LOCATION SIMILARITY SYSTEMS AND METHODS

(71) Applicant: Spirion, LLC, Tampa, FL (US)

(72) Inventor: Liam Irish, Temple Terrace, FL (US)

(21) Appl. No.: 18/088,233

(22) Filed: Dec. 23, 2022

Related U.S. Application Data
(60) Provisional application No. 63/293,452, filed on Dec. 23, 2021.

(51) Int. Cl. G06F 21/62; G06F 18/23213; G06F 18/2413

(52) U.S. Cl. CPC G06F 21/6245; G06F 18/23213; G06F 18/24147

(57) ABSTRACT

Techniques for comparing and grouping data locations based on personally identifying information or other subdata of interest. In one embodiment, a method includes ingesting data from multiple locations digitally stored in an electronic system and scanning the ingested data to discover sensitive information present in the ingested data. The method also includes classifying each location of a first subset of the multiple locations such that the multiple locations include classified locations and unclassified locations and grouping the multiple locations into clusters based on similarity of the discovered sensitive information present at the multiple locations. Each location of a second subset of the multiple locations is classified based on the presence of that location in a cluster with a classified location of the first subset of the multiple locations. Additional systems and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

Data is essential for organizations to operate in the modern business landscape. Data is needed on their organization, their competitors, and their customers. Other data can be inadvertently collected in the process of gathering the data. Data is an ever-increasing asset, crossing traditional boundaries between on-premises and in-cloud services. It does not remain constant or stay put. In addition, low-cost storage options and the cloud are accelerating data sprawl by making it easier for companies to hold on to all their data—whether they need it or not. While computer systems—and organizations which run on them—contain large amounts of data, often much of this data may be irrelevant to a given task and finding relevant data is a needle-in-a-haystack problem.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Some embodiments of the present disclosure relate to systems and methods for comparing, classifying, and clustering data locations (e.g., documents, database rows, images, etc.) based on subdata of interest (e.g., sensitive information or the like) within the locations. In some instances, a system ingests data from the data locations, normalizes the data to reduce false negatives, and structures results as a graph so various search and visualization algorithms can be applied. It then presents this data and supports an operator in performing an open-ended set of activities based on location similarity. Irrelevant information may be filtered out to facilitate discovery of the target data (e.g., the subdata of interest). In some embodiments, the target data is sensitive information, such as personally identifying information (P 11) or personal health information (PHI). In other instances, however, the present techniques may be applied to other systems that provide a discovery output and a normalization mechanism.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts an electronic system having devices with stored data, which may be discovered, compared, classified, and clustered, in accordance with one embodiment of the present disclosure;

FIG. 2 is a diagram depicting ingestion and processing of data by a data ingestion system in accordance with one embodiment;

FIG. 3 depicts an example of normalization of data in accordance with one embodiment;

FIGS. 4 and 5 depict data locations exhibiting similarity in accordance with some embodiments;

FIG. 6 is a diagram depicting classification of data locations in accordance with one embodiment;

FIG. 7 is a diagram depicting clustering of data locations in accordance with one embodiment;

FIG. 8 is a diagram depicting a process for finding documents or information similar to a provided exemplar document in accordance with one embodiment;

FIG. 9 is a flowchart representing a method for clustering and classifying data locations in accordance with one embodiment;

FIG. 10 is a flowchart representing a method for clustering data locations based on measured distances between the locations in accordance with one embodiment; and

FIG. 11 is a block diagram of components of a programmed computer system for comparing, classifying, and clustering data locations based on subdata of interest in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

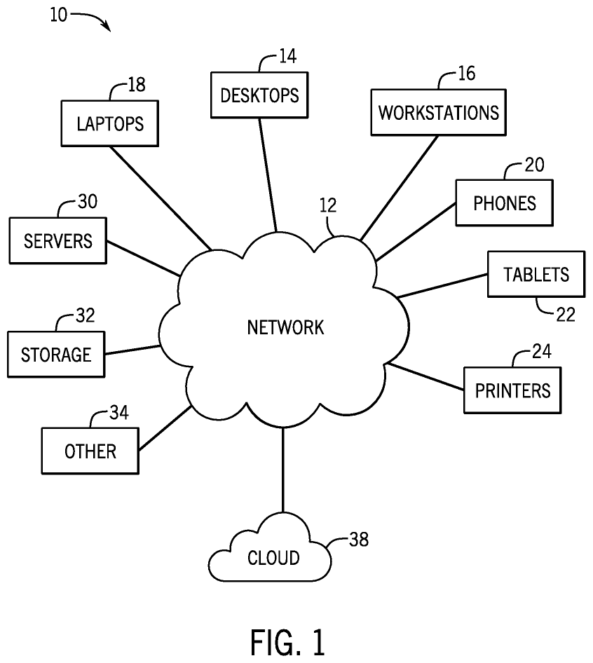

Turning now to the present figures, FIG. 1 shows an example of an electronic system 10 in the form of an information technology (IT) system, such as an IT system for an organization. The system 10 includes various devices connected via a network 12. In this depicted embodiment, these devices include various endpoints, such as desktop computers 14, workstation computers 16, laptop computers 18, phones 20, tablets 22, and printers 24. The system 10 can also include servers 30 (e.g., infrastructure servers, application servers, or mail servers), storage 32 (e.g., file servers, database servers, other storage servers, relational database systems, or network attached storage), and other networked devices 34. Still further, in at least some instances, the network 12 is connected to various cloud resources 38, which may include systems described herein in a virtualized or otherwise mediated representation. Various devices of the system 10 may be local or remote and can communicate with other devices via any suitable communication protocols.

The devices of system 10 can store a large amount of data, some of which may be sensitive information. Examples of sensitive information include PII, PHI, trade secrets, government-restricted information (e.g., classified or regulated information), information identified by an entity as sensitive through data governance policies, and other confidential information. As used herein, “location” is a descriptor pointing to data within a system, such as within the IT system 10 of an organization. The location “contains” the data. Examples of data locations include files (the location is the computer and file path, potentially including an offset within the file); relational databases (which include hostname, schema, table, row, and column); nonrelational (e.g., NoSQL) databases, which have various other internal descriptors for data within them; and uniform resource locators (URLs), which are themselves already fully qualified descriptors for data locations. Data locations can contain one or more of PII, PHI, or other sensitive information.

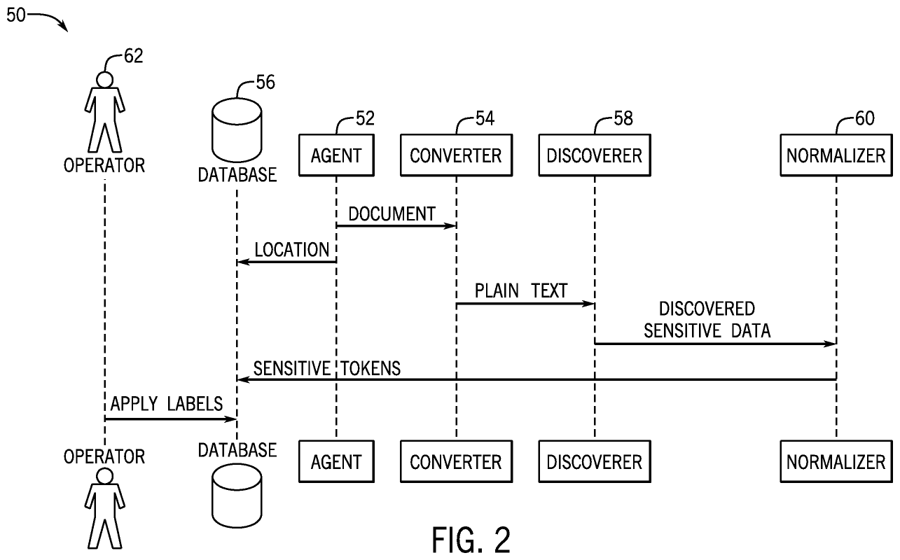

As noted above, certain embodiments relate to systems and methods for comparing, classifying, and clustering locations based on PII, PHI, or other sensitive information within the locations. Data may be ingested from the locations in any suitable manner. One example of data ingestion system 50 is generally shown in FIG. 2. In this depicted embodiment, the data ingestion system 50 includes a receiving agent 52, a converter 54, a database 56, a discoverer 58, and a normalizer 60 to ingest data, discover sensitive data, and facilitate interaction with an operator 62 (which may be a person or a software agent). Data may be received by the agent 52 of the system 50 from another source, such as a data discovery engine or agent. The data received by the agent 52 can include locations and information contained at those locations. In some cases, a user (e.g., operator 62) may send a request to the agent 52 to begin the process described below.

In the example of FIG. 2, the agent 52 passes a received document having stored information to the converter 54, which converts information stored in the document into plain text in any suitable manner, such as extracting, parsing, and translating the information stored in the document through known techniques. The plain text may be passed to the discoverer 58 for processing. The discoverer 58 is used to discover target data (e.g., subdata of interest) within the information. In at least some instances, the target data is sensitive data contained within the information. The discoverer 58 can analyze the plain text to discover sensitive data. In some embodiments, the discoverer 58 is implemented as a sensitive data discovery tool provided by Spirion, LLC, of St. Petersburg, Fla., but may be provided in any other suitable form in other embodiments. While the example of FIG. 2 includes converting information to plain text for discovery of sensitive data, it will be appreciated that information received by the agent 52 in a plain text format may be passed directly from the agent 52 to the discoverer 58, and that the discoverer 58 may be configured to discover sensitive data within information that is embodied in some format other than plain text in other embodiments.

As also shown in FIG. 2, discovered sensitive data, which may be considered relevant data, is passed from the discoverer 58 to the normalizer 60. In at least some embodiments, the remaining data (which may be considered irrelevant data) is not passed to the normalizer 60 and may be disregarded. Discovered sensitive data may be normalized (by the normalizer 60) in any suitable manner. By way of further explanation, “sensitive data type” is used herein to refer to a general attribute common amongst a set of data items. Several examples of sensitive data types include a social security number, a name, a phone number, a credit card number, and an address. Sensitive data types can have a normal representation (format), which may also be referred to as a standard representation. For example, a normal representation (e.g., a canonical form) of a social security number has nine digits and two dashes (e.g., 987-65-4321). But a sensitive data type may have multiple representations, rather than just the normal representation. In the case of a social security number, for instance, an additional (non-canonical) representation may have nine digits without any dashes (e.g., 987654321). Normalization can include taking a datum which is recognized as a sensitive data type and modifying its representation to the normal representation. By normalizing representation to a canonical form (which in some instances may be arbitrarily chosen), the system can ignore minor differences in representation.

In at least some embodiments, and as discussed further below, normalization facilitates clustering or classification, and may also or instead facilitate encryption, because unnormalized data changes observed similarity. For example, consider a particular social security number found at two locations. In one location, the particular social security number has dashes. In the other, it does not. Without normalization, these two representations of the particular social security number will appear to be different numbers, interfering with similarity measurement and subsequent grouping (e.g., classification or clustering), which are discussed further below.

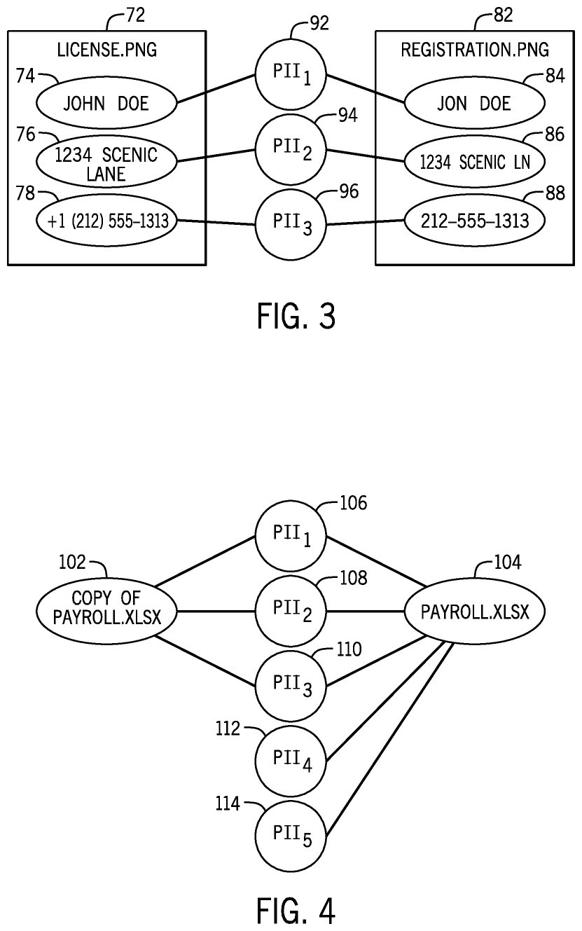

Another example of normalization is generally shown in FIG. 3. In this depicted example, a first file 72 (license.png) contains various data elements, such as a name 74 (“John Doe”), an address 76 (“1234 Scenic Lane”), and a phone number 78 (“+1 (212) 555-1313”). A second file 82 (registration.png) also contains various data elements, such as a name 84 (“Jon Doe”), an address 86 (“1234 Scenic Ln”), and a phone number 88 (“212-555-1313”). Although slight differences exist between each data element 74, 76, and 78 and its corresponding data element 84, 86, and 88, each pair of data elements (i.e., elements 74 and 84, elements 76 and 86, and elements 78 and 88) may be recognized as different representations of the same information. That is, in this example, the names 74 and 84 are different representations of the same name 92 (represented as PII₁ in FIG. 3), the addresses 76 and 86 are different representations of the same address 94 (represented as PII₂ in FIG. 3), and the phone numbers 78 and 88 are different representations of the same phone number 96 (represented as PII₃ in FIG. 3). The elements 92, 94, and 96 may be represented as canonical forms, each of which may be the same as one of the representation forms of the corresponding data elements of files 72 or 82 or may differ from each representation form of the corresponding elements of files 72 or 82. For instance, the canonical form of name 92 in FIG. 3 may be “John Doe” (as in element 74), “Jon Doe” (as in element 84), or some other representation, such as “Jonathan Doe”.

With reference again to FIG. 2, the discovered sensitive data (which may include normalized sensitive data) can be stored in the database 56 (e.g., as sensitive tokens). The locations at which the sensitive data was found may also be stored in the database 56 and each element of the sensitive data can be associated with the location at which that element was found. Connections between the sensitive data and locations may be stored in the database 56 in any suitable manner, such as one or more graphs, sets, matrices, or vectors. The operator 62 can apply descriptive labels to the identified locations for classification, such as discussed further below.

In at least some embodiments, PII or other sensitive data discovered at locations are compared and the locations are classified, clustered, or otherwise grouped based on similarity of the PII or other sensitive data. “Similarity” is the inverse of distance. That is, the more similar two entities are, the closer they are. In accordance with at least some embodiments, similarity measurement uses a metric function to calculate distance between entities. Any suitable metric function may be used, and these functions vary amongst data types. In some instances, two numbers are similar if their difference is small. But for many instances of PII or other sensitive information, two number with a small difference may not be considered similar. By way of example, for social security numbers, two numbers with a small difference do not indicate similar people, so a distance metric for a social security number may just return an indication of “same” (0) or “different” (1). Likewise, a distance metric for two credit card numbers (or license numbers, customer numbers, etc.) may just return an indication of “same” (0) or “different” (1). For the possibility of typos, other metrics, like Levenshtein distance, may be used in some instances. A plethora of distance metrics exist (e.g., taxicab distance, Euclidean distance, cosine distance, network hop distance), and they have different levels of efficacy, depending on the data type. Any suitable distance metric(s) may be used in accordance with the present techniques.

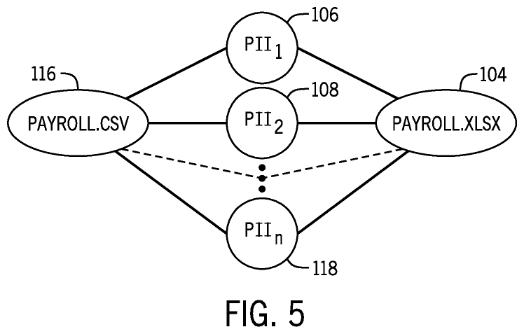

Two examples of locations exhibiting similarity are provided in FIGS. 4 and 5. The first example of FIG. 4 shows a document 104 (“payroll.xlsx”) and a document 102 (“copy of payroll.xlsx”), such as may occur if a document owner or other user created a backup copy (i.e., document 102) of an original document (i.e., document 104) but then continued to edit the original document so that the two documents are no longer identical. For instance, as generally represented by items of PII 106, 108, and 110, some PII may be found in both the original document 104 and the backup copy 102. Other items of PII, however, may only be found in one of the documents 102 or 104. In FIG. 4, this is generally represented by items of PII 112 and 114 found in the document 104 but not in the document 102 (e.g., PII added to the document 104 after the backup document 102 was created). But the backup document 102 may also or instead contain items of PII not found in the document 104, such as PII deleted from the document 104 after the backup document 102 was created.

In FIG. 5, a document 116 (“payroll.csv”) and the document 104 are in different formats but contain identical PII. While generally represented in FIG. 5 by items of PII 106, 108, and 118, the documents 104 and 116 (as well as document 102 or other documents) can contain any number of items of PII. In some embodiments of the present technique, for example, a document or other data location can contain dozens, hundreds, thousands, millions, or billions of items of PII or other sensitive data, which can be used for location similarity analysis.

Files can be compared in various manners. One approach is fingerprinting, which attempts to produce an identifier for a document (i.e., a unique “fingerprint”), such as some large number that will be unique to the file contents regardless of changes to metadata. For example, if foo.txt and bar.txt have the same content, they should have the same fingerprint in this approach. A fingerprint might be implemented by calculating a checksum or cryptographic hash (e.g., sha256sum) of the file contents. Some problems with this approach may include that: fingerprints are Boolean (i.e., two documents either have the same contents or different contents); changes to a file, even simple things such as storing the fingerprint in the file, change the file and therefore its fingerprint; fingerprints have no mechanism of comparison; and fingerprints are opaque in that they tell nothing about file contents.

Some other approaches to comparison include attempts to produce a representation (e.g., a vector) of a text document. Methods for creating document representations include a bag-of-words model, in which each word is associated with a number. The numbers in a given document map to a high dimensional vector (e.g., a 10,000-word corpus having a 10,000-dimension vector for each document). Another method is using word embedding (e.g., word2vec), in which each word has its own vector. In this case, the document can be represented as some aggregate of the word vectors (e.g., sum or mean). Similarity can be determined by computing the dot product between two vectors. One problem with these approaches is that they are sensitive to noise (e.g., replacing the words “Last name” with “Surname” will produce a slightly different vector although the meaning is unchanged; more generally, form field changes produce a different vector even without form data changes). They also contain irrelevant data—the document vector relates to the whole document, and documents with no information of interest are compared because there is no differentiation. Further, such approaches do not easily permit deeper analysis of document differences (e.g., subset, superset) and words must be contained in the corpus to contribute to the document representation (two completely different documents containing only unknown words will have the same resulting vector, such as a zero vector or some other default).

In still another approach, document classification includes applying labels to a document (after scanning the document), noting the kind of data contained in the document. In some instances, problems with this approach include that labels become desynchronized from content, labels must be defined in advance and, while labels permit grouping of similar documents, labels may not allow further comparison.

In contrast to the approaches discussed above, certain embodiments of the present technique include grouping multiple data locations based on similarity of subdata of interest (e.g., PII or other sensitive information) within the locations after ingesting data. This grouping may include clustering data locations. A cluster is a grouping by similarity. A clustering could be spatial (e.g., cluster members have small Euclidean distances) or network (cluster members are connected to each other). As with similarity, the choice of distance metric affects how clustering works. The grouping may also or instead include classification (i.e., the application of a label to a data location). Classification and clustering are related but independent, and each may be considered a form of grouping. To classify a location, one typically needs to know in advance what data types go with that classification. Rules systems and machine learning algorithms can apply labels to locations (i.e., classify locations) based on prior knowledge. Clustering requires no prior knowledge, but the clusters may not correspond to a human-comprehensible grouping.

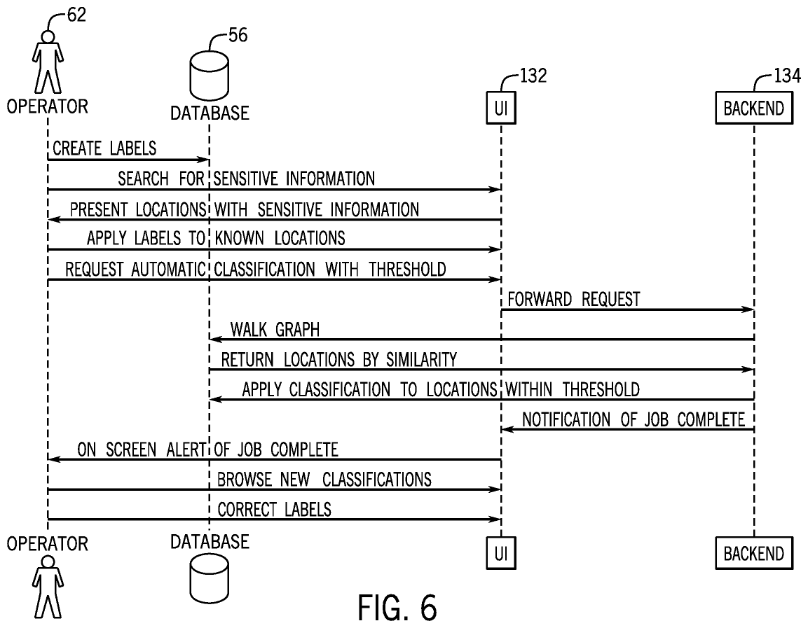

After ingesting data, an operator can use the system to classify locations, cluster locations, and find similar locations. For instance, a classification process is generally represented in FIG. 6 in accordance with one embodiment. In this example, classification means the application of labels. The system can automatically classify similar locations when a set of labels are applied to a subset of locations and a distance threshold is given, within which other locations will have matching labels applied. With reference to FIG. 6, the operator 62 can create labels to be applied to sensitive information contained in the database 56. User interaction with the system can be facilitated by a user interface 132. In at least some instances, including that shown in FIG. 6, the operator 62 can search for sensitive information (e.g., in the database 56) via the user interface 132, which can present locations having sensitive information to the operator 62. The operator 62 can apply labels to one or more known locations, such as by manually reviewing data of a location and applying an appropriate label to that location. Each of the labels to be applied to sensitive information can be created before or after the operator 62 searches for sensitive information. That is, in some instances, a given label may be created (or modified) after sensitive information is found (e.g., the label may be created or modified to better describe the information found).

Further, in at least some embodiments the operator 62 can request automatic classification based on a distance threshold. This automatic classification request can be provided by the user interface 132 to a backend 134. In certain embodiments, the database 56 includes a graph database and the backend 134 walks the graph to return locations by pairwise similarity. The backend 134 then applies classification to returned locations within the distance threshold of a labeled location. That is, once a label is applied (e.g., by the operator 62) to a known location, the backend 134 can find other locations and then automatically extend the label that was applied to the known location to other locations that are sufficiently close to the labeled location (i.e., the pairwise distance between the known location and the other location is within a distance threshold). As also shown in FIG. 6, the backend 134 can provide notice that automatic classification has been completed and the user interface 132 can provide an on-screen alert to the operator 62. Additionally, the operator 62 can browse the new (automatic) classifications and, in the event of misclassification, correct labels applied to locations. In some instances, the backend 134 may facilitate application of labels to locations and correction of labels of locations by the operator 62.

Classification is labor-intensive for an operator 62, however, and an operator 62 may not know what kind of information is contained within a set of locations. Clustering permits the grouping of similar nodes without operator intervention. The operator 62 may then browse the graph (or other data representation) to discover the structure of the locations. There are many tools for clustering graphs, examples of which include Jaccard similarity, max flow, and simple edge counting. Any suitable clustering tool may be used in full accordance with the present techniques.

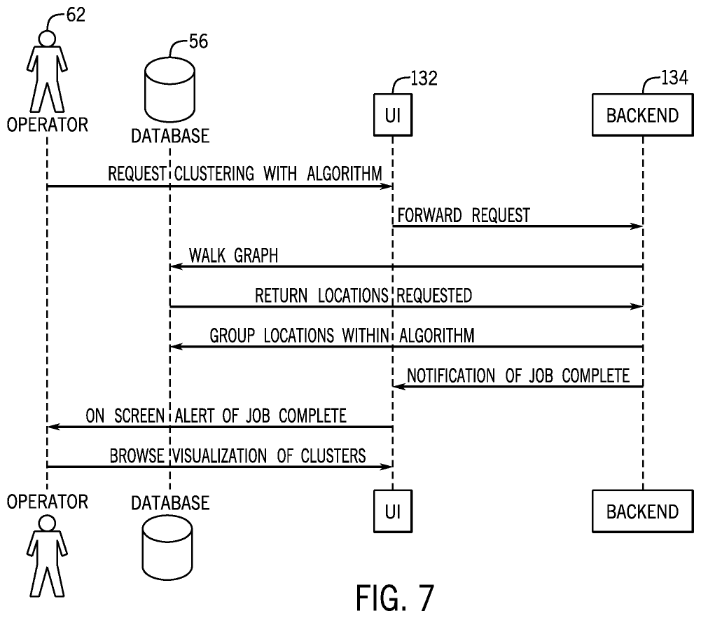

A clustering process is generally represented in FIG. 7 in accordance with one embodiment. In this example, the operator 62 can request, via the user interface 132, clustering with an algorithm, such as a K-means clustering algorithm or expectation-maximization clustering algorithm. This request may be passed to the backend 134, which may then walk the graph of locations to return locations requested. The returned locations may be clustered or otherwise grouped via the clustering algorithm. After clustering, the operator 62 may browse one or more visualizations of the clusters via the user interface 132.

Location similarity may also or instead be used to find documents that are similar to a given document. For example, an organization may have a person's resume and may wish to see if another version of this person's resume is already on file. Finding similar documents can make use of the same similarity graph algorithms found above but applied serially as an operator requests. The operator may also make use of the above techniques in combination with serial browsing. This technique may also be used for Subject Rights Requests, and other compliance-related work.

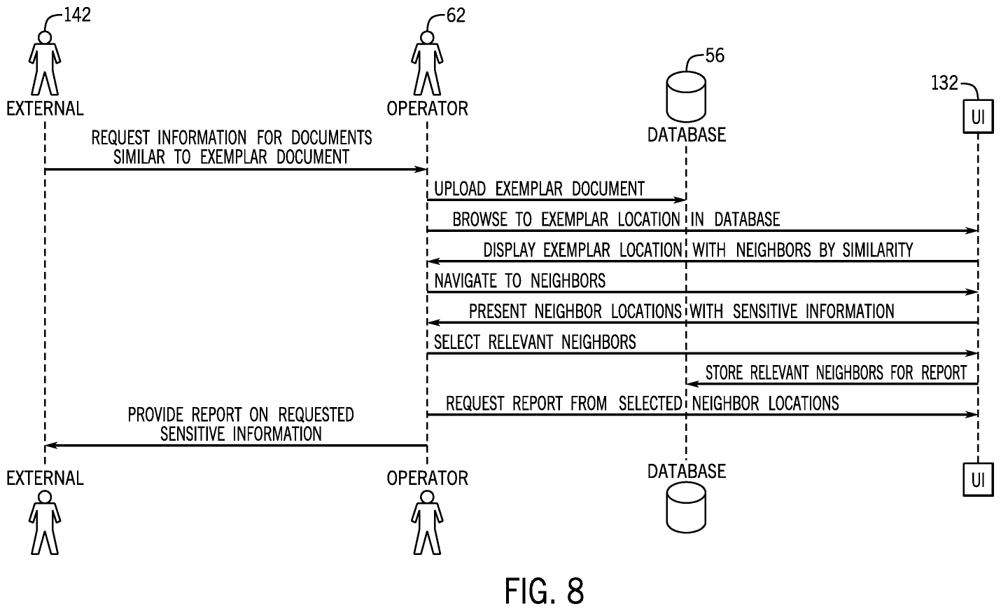

A process for finding similar documents or information is generally represented in FIG. 8 in accordance with one embodiment. In this example, an external user 142 requests from the operator 62 information for documents similar to an exemplar document. The operator 62 uploads the exemplar document to the database 56 and browses to the exemplar location in the database 56 via the user interface 132, which displays the exemplar location with neighbors by similarity. The operator 62 can navigate to displayed neighbors, and the user interface 132 can present neighbor locations with sensitive information. The operator 62 can select relevant neighbors (e.g., those neighbors confirmed to be similar to the exemplar document), which can be stored in the database 56 for reporting purposes. The operator 62 can request a report from the selected neighbor locations via the user interface 132. The report generated in response to this request can be forwarded by the operator 62 to the external user 142 or used by the operator 62 to prepare a different report (e.g., a summary) for the external user 142.

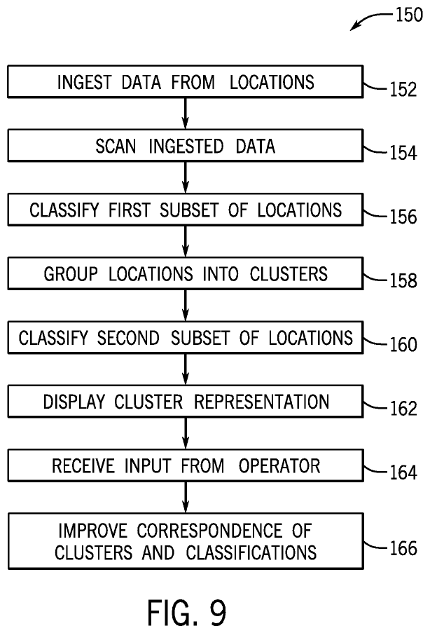

An example of a method for clustering and classifying locations is generally represented by flowchart 150 of FIG. 9. In this depicted embodiment, the method includes ingesting data from locations (block 152) and scanning the ingested data (block 154). More specifically, the ingested data may be from multiple locations digitally stored in an electronic system and may be scanned to discover personally identifying information (or other sensitive information) present in the ingested data. The method also includes classifying (block 156) each location of a first subset of the multiple locations, such that the multiple locations include classified locations and unclassified locations, and grouping (block 158) the multiple locations (classified and unclassified) into clusters based on similarity of the discovered personally identifying information present at the multiple locations. This classifying and clustering may be performed in any suitable manner, such as via the techniques described above.

The method also includes classifying (block 160) each location of a second subset of the multiple locations based on the presence of that location in a cluster with a classified location of the first subset of the multiple locations. In at least some instances, this classification of each location of the second subset is performed automatically based on the presence of that location in a cluster with a previously classified location. That is, classification of a labeled location may be automatically extended to one or more unlabeled locations based on their similarity with the labeled location.

One or more cluster representations may be displayed (block 162) to an operator (e.g., operator 62), such as via the user interface 132. In some instances, this includes displaying a graphical representation (a visualization) of the clusters to the operator. Still further, input may be received (block 164) from the operator to iteratively improve (block 166) the correspondence of clusters and classifications. As an example, the operator 62 may change a classification of a location (e.g., a location of the second subset), which may then be used by the system to re-cluster the locations and update labels based on similarity.

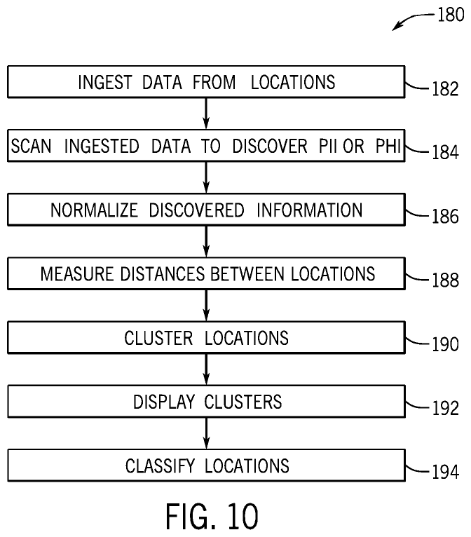

An example of a method for clustering locations based on measured distances between the locations is generally represented by flowchart 180 of FIG. 10. In this depicted embodiment, the method includes ingesting data (block 182) from multiple locations digitally stored in an electronic system and scanning (block 184) the ingested data to discover personally identifying information or personal health information (or other sensitive information) present in the ingested data. The method also includes normalizing (block 186) the discovered personally identifying information or personal health information present in the ingested data. Distances between the locations are then measured (block 188) based on similarities between the discovered personally identifying information or personal health information present in the ingested data. Based on these measured distances, the locations may be clustered (block 190). A representation (e.g., a graphical representation) of the location clusters may be displayed (block 192), such as via the user interface 132. In some embodiments, a user interface may be used to display contents of a location selected by a user from the displayed representation.

The method can also include classifying (block 194) at least one location based on the discovered personally identifying information or personal health information. In one embodiment, for instance, this classification includes receiving a user input applying a classification label to a first location in a first location cluster and, in response to the user input applying the classification label to the first location, automatically applying the classification label to one or more additional locations of the first location cluster based on their presence in the first location cluster with the first location. In some instances, a user may change the automatically applied classification label for one or more locations, which may cause the system to automatically apply the changed classification label to at least one other similar location.

In another embodiment, a method for classifying locations with similar relevant information includes ingesting data from various locations to discover relevant information (e.g., sensitive information) in an enterprise and scanning ingested data to discover relevant information based on various techniques (e.g., with plugins). Discovered information can be normalized to match standard formatting. The method also includes classifying locations based on similarity within a subset of relevant data, measuring distance between locations based on similarity of relevant data, clustering locations based on degree of similarity, and expanding classifications based on clusters of similar locations. The clusters or classifications (or both) may be displayed and, in some instances, navigated by a user.

Additionally, in one embodiment a method for discovering, classifying, and clustering sensitive information (SI) includes ingesting organization data to discover sensitive information in the organization, recognizing SI based on machine learning patterns, normalizing SI based on known mappings, and classifying locations based on similarity between recognized SI. This method also includes measuring distance between locations based on SI similarity, clustering locations based on matched normalized SI, and classifying unclassified locations within a cluster based on their similarity to classified locations. Further, the method includes displaying clusters and classifications to a user, which may include providing visualization (e.g., spatial, network) of clusters, showing labels of classified locations within the visualization, and providing a query interface to display classified locations without visualization (e.g., as a table or list).

In another embodiment, a method for discovering, classifying, clustering, and navigating SI includes ingesting enterprise data to discover SI, recognizing SI based on an array of machine learning pattern matchers, normalizing SI based on an array of normalization functions, and classifying locations based on recognized SI found at the location. The method also includes measuring distance using various definable metrics between locations based on metrics of recognized SI, clustering locations based on the measured distances, and expanding classifications within a cluster based on the similarity of clustered locations. Classifications, clusters, and locations may be displayed to a user and, in some instances, the user may navigate clusters to investigate SI and location attributes.

Further, in one embodiment a method for allowing a person to learn about and classify SI within their organization based on clusters of similar locations includes adding normalization functions (mappings from raw to normal format), enabling and disabling recognizers, weighting recognized SI types to adjust distances, and analyzing clusters of locations. This method can also include browsing SI within clusters, labeling (classifying) a subset of clustered locations, reviewing and correcting labels for misclassified documents, and re-clustering based on new weights, which can include analyzing and pursuing recommendations.

Still further, in one embodiment a method for allowing a person to learn about, classify, cluster, and navigate a model of locations (files, database, URLs) within an enterprise includes: adding, enabling, and disabling normalization functions (mapping from raw to normal format, such as all digit to dashed digit social security number); adding, enabling, and disabling machine learning recognizers; weighting and re-weighting SI types to adjust distances to match enterprise cluster expectations; and analyzing clusters of locations, which may include viewing with various distance visualization techniques (network, spatial) and computing various statistics on cluster. The method can also include browsing details of a cluster (or clusters), such as viewing types of SI associated with a cluster, viewing types of locations within a cluster, and drilling down to locations and SI found at those locations. A subset of clustered locations may be labeled (classified), such as by applying organization specific labels to locations or SI types and automatically applying labels to unlabeled locations within the same cluster. The method can also include reviewing and reclassifying misclassified locations, which may include drilling down and viewing types to verify correct labelling and re-labeling any incorrect labeling. Further, the method can include changing weights and re-clustering, such as changing weights to change cluster characteristics, re-running clustering to adjust cluster membership when labeled classifications are correct, and automatically re-labeling mislabeled locations when their cluster changes. Still further, the method can include analyzing locations and statistics on SI types and pursuing recommendation, which may include using built-in industry standard recommendations, adding organization recommendations to local documentation, displaying documentation for relevant locations and SI types, and interfacing with other systems to rectify issues.

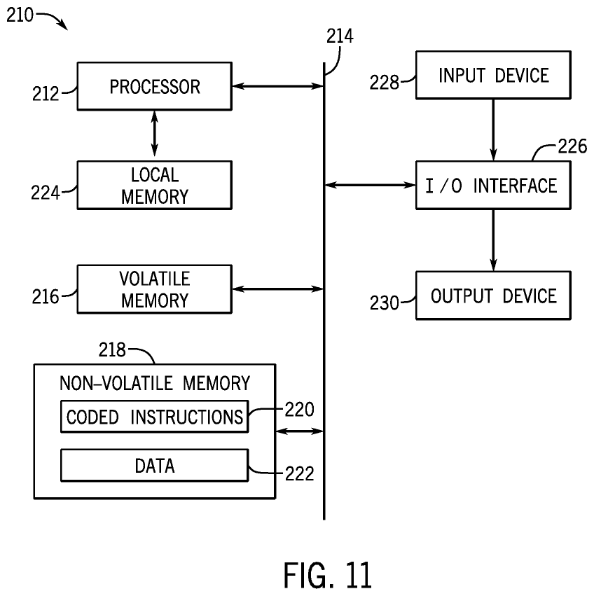

Finally, those skilled in the art will appreciate that a computer can be programmed to facilitate performance of the above-described processes. One example of such a computer is generally depicted in FIG. 11 in accordance with one embodiment. In this example, a computer system 210 includes a processor 212 connected via a bus 214 to volatile memory 216 (e.g., random-access memory) and non-volatile memory 218 (e.g., a hard drive, flash memory, or read-only memory (ROM)). Coded application instructions 220 and data 222 are stored in the non-volatile memory 218. The instructions 220 and the data 222 may also be loaded into the volatile memory 216 (or in a local memory 224 of the processor) as desired, such as to reduce latency and increase operating efficiency of the computer 210. The coded application instructions 220 can be provided as software that may be executed by the processor 212 to enable various functionalities described herein. Non-limiting examples of these functionalities include comparing, classifying, and clustering data locations based on subdata of interest, such as described above. In at least some embodiments, the application instructions 220 are encoded in a non-transitory computer readable storage medium, such as the volatile memory 216, the non-volatile memory 218, the local memory 224, or a portable storage device (e.g., a flash drive or a compact disc).

An interface 226 of the computer system 210 enables communication between the processor 212 and various input devices 228 and output devices 230. The interface 226 can include any suitable device that enables this communication, such as a modem or a serial port. In some embodiments, the input devices 228 include a keyboard and a mouse to facilitate user interaction, while the output devices 230 include displays, printers, and storage devices that allow output of data received or generated by the computer system 210. Input devices 228 and output devices 230 may be provided as part of the computer system 210 or may be separately provided. It will be appreciated that computer system 210 may be a distributed system, in which some of its various components are located remote from one another, in some instances.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. A computer-implemented method comprising:
ingesting data from multiple locations digitally stored in an electronic system;
scanning the ingested data to discover personally identifying information or personal health information present in the ingested data;
measuring distances between the locations based on the discovered personally identifying information or personal health information present in the ingested data;
clustering the locations based on the measured distances between the locations; and
displaying, via a user interface, a representation of location clusters resulting from the clustering of the locations based on the measured distances between the locations.

2. The method of claim 1, comprising normalizing the discovered personally identifying information or personal health information present in the ingested data.

3. The method of claim 2, wherein measuring distances between the locations based on the discovered personally identifying information or personal health information includes measuring distances between the locations based on the normalized discovered personally identifying information or personal health information.

4. The method of claim 1, comprising classifying at least one location based on the discovered personally identifying information or personal health information.

5. The method of claim 4, wherein classifying the at least one location based on the discovered personally identifying information or personal health information comprises:
receiving a user input applying a classification label to a first location in a first location cluster; and
in response to the user input applying the classification label to the first location, automatically applying the classification label to one or more additional locations of the first location cluster based on their presence in the first location cluster with the first location.

6. The method of claim 5, wherein automatically applying the classification label to one or more additional locations of the first location cluster based on their presence in the first location cluster with the first location includes automatically applying the classification label to each additional location that is present in the first location cluster with the first location.

7. The method of claim 5, comprising:
receiving a user input changing the automatically applied classification label of at least one location of the one or more additional locations; and
in response to the user input changing the automatically applied classification label of the at least one location, automatically applying the changed classification label to at least one other location of the one or more additional locations.

8. The method of claim 5, wherein classifying the at least one location based on the discovered personally identifying information or personal health information comprises:
receiving a user input applying an additional classification label to a second location that is in a second location cluster; and
in response to the user input applying the additional classification label to the second location, automatically applying the classification label to one or more additional locations of the second location cluster based on their presence in the second location cluster with the second location.

9. The method of claim 1, wherein displaying the representation of location clusters resulting from the clustering of the locations based on the measured distances between the locations includes displaying a graphical representation of location clusters resulting from the clustering of the locations based on the measured distances between the locations.

10. The method of claim 9, comprising displaying, via the user interface, contents of a location selected by a user from the graphical representation of the location clusters.

11. The method of claim 1, wherein measuring distances between the locations based on the discovered personally identifying information or personal health information present in the ingested data includes determining a Levenshtein distance between a first item of personally identifying information and a second item of personally identifying information.

12. A computer-implemented method comprising:
ingesting data from multiple locations digitally stored in an electronic system;
scanning the ingested data to discover sensitive information present in the ingested data;
classifying each location of a first subset of the multiple locations such that the multiple locations include classified locations and unclassified locations;
grouping the multiple locations into clusters based on similarity of the discovered sensitive information present at the multiple locations; and
classifying each location of a second subset of the multiple locations based on the presence of that location in a cluster with a classified location of the first subset of the multiple locations.

13. The method of claim 12, comprising iteratively improving correspondence of the clusters and classifications via input from an operator.

14. The method of claim 12, wherein a first location is a classified location within the first subset of the multiple locations, a second location is within the second subset of the multiple locations, both the first location and the second location are grouped into a same cluster, and wherein classifying each location of the second subset of the multiple locations based on the presence of that location in the cluster with the classified location of the first subset of the multiple locations includes automatically extending a classification of the first location to the second location based on the presence of the second location in the same cluster with the first location.

15. The method of claim 12, comprising displaying, via a user interface, a representation of the clusters.

16. The method of claim 15, wherein displaying the representation of the clusters includes displaying a graphical representation of the clusters.

17. An apparatus comprising:
a processor-based computer system including a memory and a processor, the memory having computer-readable instructions that, when executed, cause the computer system to:
search data locations digitally stored within an electronic system for personally identifying information;
present, to an operator, data locations found to have personally identifying information from the search of the data locations;
receive, from the operator, a classification label selection for a first data location of the data locations found to have personally identifying information and presented to the operator;
apply a classification label to the first data location in accordance with the classification label selection received from the operator; and
classify additional data locations of the data locations found to have personally identifying information in response to the application of the classification label to the first data location, wherein classifying the additional data locations includes computing a respective distance between each of the additional data locations and the first data location, comparing the respective distances to a distance threshold, and automatically applying the classification label that was applied to the first data location to a subset of the additional data locations based on the comparison of the respective distances to the distance threshold.

18. The apparatus of claim 17, wherein the memory has computer-readable instructions that, when executed, cause the computer system to display a graphical representation of the first data location and one or more of the additional data locations.

19. The apparatus of claim 17, wherein the memory has computer-readable instructions that, when executed, cause the computer system to cluster the data locations based on the computed distances.

20. The apparatus of claim 17, wherein the electronic system includes a computer network in which at least some of the multiple locations are digitally stored.
